(19) United States
(12) Patent Application Publication
(10) Pub. No.: US 2020/0392013 A1
(43) Pub. Date: Dec. 17, 2020

(54) METHOD FOR PRODUCING INDIUM TIN OXIDE PARTICLES AND METHOD FOR PRODUCING CURABLE COMPOSITION

(71) Applicant: FUJIFILM Corporation, Tokyo (JP)

(72) Inventors: Masahiro TAKATA, Kanagawa (JP); Masashi ONO, Kanagawa (JP)

(73) Assignee: FUJIFILM Corporation, Tokyo (JP)

(21) Appl. No.: 17/003,997

(22) Filed: Aug. 27, 2020

Related U.S. Application Data
(63) Continuation of application No. PCT/JP2019/008247, filed on Mar. 1, 2019.

(30) Foreign Application Priority Data
Mar. 8, 2018 (JP) 2018-042005

(51) Int. Cl. C01G 19/02; C08F 20/14

(52) U.S. Cl. CPC C01G 19/02; C08K 2003/2231; C08F 20/14

(57) ABSTRACT

Provided are a method for producing indium tin oxide particles, the method including a step of obtaining a precursor solution including indium and tin by heating an indium carboxylate having 1 to 3 carbon atoms and a tin carboxylate having 1 to 3 carbon atoms in a solvent including a carboxylic acid having 6 to 20 carbon atoms, a step of obtaining a reaction solution including indium tin oxide particles by adding dropwise, at a dropping rate of 1.0 mL/min or more, the obtained precursor solution to a solvent which has a hydroxyl group, has 14 to 22 carbon atoms, and has a temperature of 230° C. to 320° C., and a step of, after a completion of the dropwise addition of the precursor solution, retaining the obtained reaction solution under a temperature condition of 230° C. to 320° C. for 60 minutes to 180 minutes; and a method for producing a curable composition including the obtained indium tin oxide particles.

### CROSS-REFERENCE TO RELATED APPLICATIONS

This application is a continuation application of International Application No. PCT/JP2019/008247, filed Mar. 1, 2019, which is incorporated herein by reference. Further, this application claims priority from Japanese Patent Application No. 2018-042005, filed Mar. 8, 2018, which is incorporated herein by reference.

### BACKGROUND OF THE INVENTION

### 1. Field of the Invention

The present disclosure relates to a method for producing indium tin oxide particles and a method for producing a curable composition.

### 2. Description of the Related Art

Indium tin oxide particles (hereinafter, sometimes referred to as “ITO particles”) can be used for various uses. Among these, ITO particles having a high absorbance in a near infrared region are useful for forming an optical material such as a diffraction grating lens and an infrared filter, and can achieve a composite material having a low Abbe number.

Therefore, various methods for producing ITO particles having absorption in a near infrared region at a wavelength of 1900 nm or less have been studied.

For example, as a method for producing metal oxide particles including a plurality of metal species at low temperature, a method for producing metal oxide nanoparticles by preparing a solution including a carboxylic acid metal salt and a carboxylic acid and adding dropwise the obtained solution to an alcohol at a temperature of 250° C. or lower to react is suggested (refer to the specification of US2015/0259217A and ‘Continuous Growth of Metal Oxide Nanocrystals: Enhanced Control of Nanocrystal Size and Radial Dopant Distribution’, American Chemical Society, Vol. 10, pp. 6942 to 6951 (2016)).

### SUMMARY OF THE INVENTION

Nanosized metal oxide particles such as ITO particles can be produced by the methods described in the references. However, the methods specifically described in the references as a suitable producing method are a method for obtaining particles by adjusting a dropping rate of a precursor solution including a metal oxide to 0.5 mL (milliliter)/minute or less to cause a particle formation reaction, and maintaining a reaction temperature in the liquid for 30 minutes. In the producing method, since the dropping rate is slow, the synthesis of ITO particles takes a long time. For example, in a case where the total amount of the precursor solution added dropwise is 500 mL, at least 16 hours is required for the synthesis. It is not practical to apply the methods described in the references to an industrial scale.

In addition, according to the studies by the present inventors, it has been found that, in the methods described in the references, in a case where only the dropping rate of the precursor solution is increased, a plasmon resonance peak of the obtained ITO particles shifts to a long wavelength side. In a case of shifting the plasmon resonance peak of the ITO particles to the long wavelength side, a low Abbe number cannot be obtained in an optical material such as a resin composition obtained by using the ITO particles. Therefore, there is a problem that the ITO particles obtained by the methods described in the references are difficult to be applied to the optical material.

An object to be achieved by an embodiment of the present invention is to provide a method for producing indium tin oxide particles, which is capable of efficiently producing indium tin oxide particles having absorption in a near infrared region.

An object to be achieved by another embodiment of the present invention is to provide a method for producing a curable composition which includes indium tin oxide particles having absorption in a near infrared region, has a low Abbe number, and is useful for use of an optical material.

The methods for achieving the above-described objects include the following aspects.

<1> A method for producing indium tin oxide particles, the method comprising:

a step of obtaining a precursor solution including indium and tin by heating an indium carboxylate having 1 to 3 carbon atoms and a tin carboxylate having 1 to 3 carbon atoms in a solvent including a carboxylic acid having 6 to 20 carbon atoms;

a step of obtaining a reaction solution including indium tin oxide particles by adding dropwise, at a dropping rate of 1.0 mL/min or more, the obtained precursor solution to a solvent which has a hydroxyl group, has 14 to 22 carbon atoms, and has a temperature of 230° C. to 320° C.; and

a step of, after a completion of the dropwise addition of the precursor solution, retaining the obtained reaction solution under a temperature condition of 230° C. to 320° C. for 60 minutes to 180 minutes.

<2> The method for producing indium tin oxide particles according to <1>,

in which, in the step of obtaining a precursor solution including indium and tin, an amount of the indium carboxylate having 1 to 3 carbon atoms and the tin carboxylate having 1 to 3 carbon atoms is used such that an amount of tin with respect to a total amount of indium and tin is 0.05 to 0.15 in a molar ratio.

<3> The method for producing indium tin oxide particles according to <1> or <2>,

in which a total molar concentration of metals included in the precursor solution is 0.1 mmol/mL or more.

<4> The method for producing indium tin oxide particles according to any one of <1> to <3>,

in which, in a case where a content of the hydroxyl group included in the solvent which has a hydroxyl group and has 14 to 22 carbon atoms is denoted by A mol, and a content of the carboxylic acid included in the precursor solution and having 6 to 20 carbon atoms is denoted by B mol, A and B satisfy a condition of Expression (I).

B/(A+B)<0.5 Expression (I)

<5> The method for producing indium tin oxide particles according to any one of <1> to <4>,

in which the carboxylic acid having 6 to 20 carbon atoms includes oleic acid.

<6> The method for producing indium tin oxide particles according to any one of <1> to <5>,

in which the indium carboxylate having 1 to 3 carbon atoms includes indium acetate, and

the tin carboxylate having 1 to 3 carbon atoms includes tin acetate.

<7> The method for producing indium tin oxide particles according to any one of <1> to <6>,

in which the solvent which has a hydroxyl group and has 14 to 22 carbon atoms includes oleyl alcohol.

<8> A method for producing a curable composition, the method comprising:

a step of obtaining indium tin oxide particles by the method for producing indium tin oxide particles according to any one of <1> to <7>; and

a step of obtaining a curable composition having absorption in a near infrared region by mixing the obtained indium tin oxide particles and a polymerizable compound.

According to an embodiment of the present invention, it is possible to provide a method for producing indium tin oxide particles, which is capable of efficiently producing indium tin oxide particles having absorption in a near infrared region.

According to another embodiment of the present invention, it is possible to provide a method for producing a curable composition which includes indium tin oxide particles having absorption in a near infrared region, has a low Abbe number, and is useful for use of an optical material.

### BRIEF DESCRIPTION OF THE DRAWINGS

FIG. 1 is a graph showing absorption characteristics of ITO particle dispersions in Examples 1 to 3 and Comparative Examples 1 and 2.

FIG. 2 is a draw showing a correlation between a retention time of a reaction solution and a plasmon absorption peak wavelength of obtained ITO particles in Examples 1 to 3 and Comparative Examples 1 and 2.

### DESCRIPTION OF THE PREFERRED EMBODIMENTS

Hereinafter, the contents of the present disclosure will be described.

The description of constituent elements below is made based on representative embodiments of the present disclosure, but the present disclosure is not limited to the following embodiments.

In the present disclosure, a numerical range described by using “to” represents a numerical range including numerical values before and after “to” as a lower limit value and an upper limit value.

In the present disclosure, in a case where a plurality of substances corresponding to each component in a composition is present, the amount of each component in the composition means the total amount of the plurality of substances present in the composition, unless otherwise specified.

In a numerical range described in a stepwise manner in the present disclosure, an upper limit value or a lower limit value described in a certain numerical range may be replaced with an upper limit value or a lower limit value in another numerical range described in a stepwise manner. In addition, in a numerical range described in the present disclosure, an upper limit value or a lower limit value described in a certain numerical range may be replaced with a value described in Examples.

In addition, in the present disclosure, a combination of two or more preferred aspects is a more preferred aspect.

A description for a group (atomic group) in the present disclosure is used in a meaning including an unsubstituted group and a group having a substituent, unless otherwise specified. For example, “alkyl group” is used in a meaning including both of an alkyl group (unsubstituted alkyl group) having no substituent and an alkyl group (substituted alkyl group) having a substituent. The same applies to other substituents.

In addition, in the present disclosure, “(meth)acrylic” represents both or either of acrylic and methacrylic, and “(meth)acrylate” represents both or either of acrylate and methacrylate.

In the present disclosure, the term “step” includes not only the independent step but also a step in which intended purposes are achieved even in a case where the step cannot be precisely distinguished from other steps.

<Method for Producing ITO Particles>

The method (hereinafter, sometimes simply referred to as a “producing method”) for producing ITO particles according to an embodiment of the present disclosure includes a step (hereinafter, sometimes referred to as a “step (I)”) of obtaining a precursor solution including indium and tin by heating an indium carboxylate having 1 to 3 carbon atoms and a tin carboxylate having 1 to 3 carbon atoms in a solvent including a carboxylic acid having 6 to 20 carbon atoms; a step (hereinafter, sometimes referred to as a “step (II)”) of obtaining a reaction solution including indium tin oxide particles by adding dropwise, at a dropping rate of 1.0 mL/min or more, the obtained precursor solution to a solvent which has a hydroxyl group, has 14 to 22 carbon atoms, and has a temperature of 230° C. to 320° C.; and a step (hereinafter, sometimes referred to as a “step (III)”) of, after a completion of the dropwise addition of the precursor solution, retaining the obtained reaction solution under a temperature condition of 270° C. to 320° C. for 60 minutes to 180 minutes.

According to the producing method according to the embodiment of the present disclosure, it is possible to efficiently produce ITO particles having absorption in a near infrared region. Specifically, even in a case where a precursor solution is added dropwise to a solvent including a hydroxyl group at a high dropping rate of 1.0 mL/min or more, the absorption of the obtained ITO particles does not shift to the long wavelength side, and it is possible to efficiently produce ITO particles having good absorption in the near infrared region.

The effect of the present disclosure is not clear, but assumed as follows.

In general, in a case where a precursor solution including a carboxylic acid metal salt is added dropwise to the solvent (hereinafter, sometimes referred to as an “alcohol solvent”) having a hydroxyl group to form metal oxide particles, a plasmon resonance peak of the obtained ITO particles shifts to the long wavelength side in a case where only the dropping rate of the precursor solution is increased. The reason why the plasmon resonance peak of the obtained ITO particles shifts to the long wavelength side is assumed that, in a case where the dropping rate of the precursor solution is fast, the influence of impurities and the like which inhibit crystal growth cannot be ignored during the formation reaction of metal oxide particles, and a large number of defects which trap electrons are generated in the ITO particles.

In the producing method according to the embodiment of the present disclosure, after a completion of the particle formation reaction, that is, after adding dropwise the precursor solution to the alcohol solvent, a treatment of retaining the temperature of the reaction solution at 230° C. to 320° C., so-called aging, is performed. By performing the aging, that is, the retention of the temperature of the reaction solution for an appropriate time, it is considered that the defects which trap electrons in the ITO particles are compensated over time, and the plasmon resonance peak shifts to a short wavelength side.

According to the studies by the present inventors, an aging time is appropriately 60 minutes to 180 minutes, and the shift of the plasmon resonance peak to the long wavelength side is effectively suppressed in this retention time range.

It is considered that, in a case where the aging time is too short, a sufficient compensation effect of defects cannot be obtained, and in a case where the aging time is too long, since not only defects which trap electrons, but also oxygen defects which are useful for generating electrons are compensated, the number of electrons decreases and the plasmon resonance peak shifts to the long wavelength side again.

Since undesired defects are compensated and good absorption in the near infrared region is obtained, the ITO particles obtained by the producing method according to the embodiment of the present disclosure achieves a low Abbe number by applying to a diffraction grating lens and the like. Therefore, in a case where the ITO particles obtained by the producing method according to the embodiment of the present disclosure are applied to the diffraction grating lens, since the height of the diffraction grating can be lowered, it is possible to obtain an effect of reducing flare. Furthermore, it is considered that the ITO particles obtained by the producing method according to the embodiment of the present disclosure are also useful for use of filter in the near infrared region.

The present disclosure is not limited to the assumed mechanism.

Hereinafter, the producing method according to the embodiment of the present disclosure will be described in the order of steps.

[Step (I)]

The step (I) is a step of obtaining a precursor solution including indium and tin by heating an indium carboxylate having 1 to 3 carbon atoms and a tin carboxylate having 1 to 3 carbon atoms in a solvent including a carboxylic acid having 6 to 20 carbon atoms.

(Indium Raw Material and Tin Raw Material)

As an indium raw material and a tin raw material used for preparing the precursor solution, an indium carboxylate having 1 to 3 carbon atoms and a tin carboxylate having 1 to 3 carbon atoms are used.

Specific examples of the indium raw material include indium formate, indium acetate, and indium propionate, and at least one indium carboxylate selected from the group consisting of these indium raw materials is used. Among these, from the viewpoint of stability, handleability, supply stability, and cost, it is preferable that indium acetate is included as the indium raw material.

Examples of the tin raw material include tin (II) formate, tin (IV) formate, tin (II) acetate, tin (IV) acetate, tin (II) propionate, and tin (IV) propionate, and at least one tin carboxylate selected from the group consisting of these tin raw materials is used. Among these, from the viewpoint of stability, handleability, supply stability, and cost, it is preferable that tin (II) acetate and tin (IV) acetate are included as the tin raw material, and it is more preferable that tin (IV) acetate is included as the tin raw material.

By using the above-described indium raw material and tin raw material, the indium raw material and the tin raw material are easily dissolved in the solvent in a case of being heated in the solvent including a carboxylic acid having 6 to 20 carbon atoms. Therefore, it is possible to easily obtain a precursor solution in which the carboxylic acid having 6 to 20 carbon atoms is coordinated to indium and tin.

Among these, from the viewpoint of raw material cost, purity, stability, handleability, easiness of forming the precursor solution, and the like, preferred examples of a combination of the above-described indium raw material and the tin raw material include a combination of indium acetate and tin (IV) acetate.

(Solvent Used for Preparing Precursor Solution)

As the solvent for preparing the precursor solution, a solvent of an organic acid which includes a carboxylic acid having 6 to 20 carbon atoms is used.

The number of carbon atoms in the carboxylic acid is 6 to 20, preferably 14 to 20.

A hydrocarbon group in the carboxylic acid may be linear, may have a branch, or may have a ring structure as long as the hydrocarbon group has the above-described range of carbon atoms.

Among these, an unsaturated fatty acid is preferable as the carboxylic acid.

Specific examples of the solvent which includes a carboxylic acid having 6 to 20 carbon atoms include caproic acid, caprylic acid, pelargonic acid, 2-ethylhexanoic acid, capric acid, undecanoic acid, lauric acid, myristic acid, palmitic acid, stearic acid, palmitoleic acid, oleic acid, linoleic acid, and linolenic acid, one or more organic acids selected from the group consisting of the above-described organic acids is preferably used. Among these, as the solvent, one or more organic acids selected from the group consisting of caproic acid, caprylic acid, oleic acid, linoleic acid, and linolenic acid is more preferably used, and it is still more preferable to include oleic acid.

Any of the above-mentioned solvents can easily dissolve, by heating, the indium carboxylate having 1 to 3 carbon atoms and tin carboxylate having 1 to 3 carbon atoms, which are the above-described indium raw material and tin raw material, and by the dissolving, it is possible to easily obtain a precursor solution in which the carboxylic acid having 6 to 20 carbon atoms is coordinated to indium and tin respectively.

(Preparation of Precursor Solution)

The precursor solution is prepared by mixing the indium carboxylate having 1 to 3 carbon atoms and the tin carboxylate having 1 to 3 carbon atoms, and the solvent which includes a carboxylic acid having 6 to 20 carbon atoms, and heating the mixture.

The indium carboxylate and the tin carboxylate are dissolved by heating, and a solution of a precursor in which the carboxylic acid having 6 to 20 carbon atoms is coordinated (for example, in a case of using oleic acid, indium oleate and tin oleate) can be obtained.

In the step (I), it is preferable that the amount of the indium carboxylate and the tin carboxylate is used such that the amount of tin with respect to the total amount of indium and tin ([Sn/(In+Sn)]) is 0.05 to 0.15 in a molar ratio.

That is, it is preferable that the amount of the indium raw material and the tin raw material is weighed and mixed such that the amount of tin with respect to the total amount of indium and tin ([Sn/(In+Sn)]) is 0.05 to 0.15 in a molar ratio.

By including indium and tin in the above-described molar ratio range, it is easy to obtain ITO particles which can be suitably used for use of optical material such as an optical filter and an optical lens and has a plasmon resonance peak of approximately 1900 nm or less.

The total molar concentration of metals included in the precursor solution is preferably 0.1 mmol (millimol)/mL or more and more preferably 0.3 mmol/mL or more.

By setting the molar concentration of metals within the above-described range, the yield of ITO particles can be easily increased.

The upper limit of the total molar concentration of metals included in the precursor solution is not particularly limited, but from the viewpoint of better solubility, the total molar concentration of metals included in the precursor solution can be set to 5 mmol/mL or less.

The heating temperature and heating time in a case of preparing the precursor solution are appropriately selected depending on the kinds of the indium carboxylate, the tin carboxylate, and the solvent which includes a carboxylic acid having 6 to 20 carbon atoms to be used. For example, in a case where indium acetate and tin (IV) acetate are used as the raw materials, and oleic acid is used as the solvent, it is preferable to heat at a temperature having an upper limit of 140° C. to 160° C. for approximately 1 hour. Under the above-described conditions, a yellow transparent precursor solution can be obtained.

In a case of preparing the precursor solution, in order to prevent a reaction system from being mixed with impurities such as oxygen and water, the mixing of the raw materials is preferably performed in a glove box or the like in which the oxygen concentration and the moisture concentration are controlled. In addition, in a case of preparing the precursor solution by heating the raw materials and the solvent, it is preferable to flow an inert gas such as nitrogen.

The obtained precursor solution can be applied to the next step by being filled into a syringe. In a case of filling the precursor solution into the syringe, in order to avoid mixing of oxygen and water, the filling operation is preferably performed in a glove box or the like in which the oxygen concentration and the moisture concentration are controlled.

Examples of the controlled conditions of oxygen concentration and moisture concentration include conditions in which the oxygen concentration is 5 ppm or less and the moisture concentration is 1 ppm or less. However, the controlled conditions of oxygen concentration and moisture concentration are not limited to the above-described conditions.

[Step (II)]

The step (II) is a step of obtaining a reaction solution including indium tin oxide particles by adding dropwise, at a dropping rate of 1.0 mL/min or more, the obtained precursor solution to a solvent which has a hydroxyl group, has 14 to 22 carbon atoms, and has a temperature of 230° C. to 320° C.

(Solvent for Synthesizing ITO Particles)

In the preparation of the reaction solution, a solvent which has a hydroxyl group and has 14 to 22 carbon atoms is used. The solvent is selected from the viewpoint of stability at the reaction temperature.

Specific examples of the solvent which has a hydroxyl group and has 14 to 22 carbon atoms include myristyl alcohol, stearyl alcohol, palmityl alcohol, behenyl alcohol, arachidyl alcohol, palmitoleyl alcohol, oleyl alcohol, linoleyl alcohol, and docosenol.

The synthetic solvent preferably includes one or more solvents selected from the group consisting of the above-described solvents. As the solvent, from the viewpoint that workability is good since the boiling point is sufficiently lower than the reaction temperature and the melting point is a temperature at which the solution is not solid in a case of being cooled to room temperature after the reaction, one or more solvents selected from the group consisting of palmitoleyl alcohol, oleyl alcohol, and linoleyl alcohol is more preferable, and it is still more preferable to include oleyl alcohol.

ITO particles are formed in the reaction solution by heating the solvent having a hydroxyl group to a temperature condition of 230° C. to 320° C. and adding dropwise the precursor solution obtained in the step (I), in which the carboxylic acid is coordinated to indium and tin, to the solvent. As a mechanism, Metal-OH is formed according to an esterification reaction with a hydroxyl group and a carboxylic acid, and a Metal-O-Metal bond is formed by further dehydration.

In a case of the reaction, the above-described solvent having a hydroxyl group is charged into a reaction vessel such as a three-neck flask and heated. In a case of charging the solvent into the reaction vessel, in order to avoid mixing of oxygen and water into the reaction system, the charging is preferably performed in a glove box or the like in which the oxygen concentration and the moisture concentration are controlled.

The heating temperature of the solvent is 230° C. to 320° C., which is a temperature at which the ITO particles are easily formed. For example, in a case where oleyl alcohol is used as the solvent, the heating temperature is preferably 230° C. to 320° C., more preferably 250° C. to 310° C., and still more preferably 280° C. to 300° C.

(Synthesis)

ITO particles are obtained by the reaction in the solvent, in which the precursor solution obtained in the step (I) is added dropwise to the preheated solvent which has a hydroxyl group and has 14 to 22 carbon atoms at a dropping rate of 1.0 mL/min or more.

The dropping rate can be appropriately adjusted depending on the types of the indium raw material and tin raw material used in the precursor solution to be used, the concentration of the precursor solution, and the like. Among these, from the viewpoint that the ITO particles can be formed more efficiently, the dropping rate is 1.0 mL/min or more, preferably 1.5 mL/min or more.

In addition, the dropping rate has no particular upper limit, but from the viewpoint of facility cost, can be set to 100 mL/min or less.

By setting the dropping rate to 1.0 mL/min or more, for example, the amount of the precursor solution added dropwise can be set to 50 mL or more, and the ITO particles can be efficiently formed. The amount of the precursor solution added dropwise can be appropriately adjusted depending on composition of the precursor solution, the amount of the alcohol solvent to be used, and the like. The amount added dropwise is preferably 50 mL or more and more preferably 100 mL or more. In addition, from the viewpoint of facility cost, the amount added dropwise is preferably set to 5 mL or less.

In this case, since water, free acetic acid, and the like are generated with the esterification reaction, it is preferable to flow an inert gas such as nitrogen into the reaction system to discharge water, acetic acid, and the like generated outside the system, from the viewpoint that the esterification reaction is more likely to proceed and the yield of ITO particles is further improved.

The flow rate of the inert gas such as nitrogen is appropriately adjusted depending on the reaction scale, the dropping rate, and the like. Since, in a case where the flow rate of the inert gas is too low, the acetic acid and the like cannot be sufficiently discharged to the outside of the system and bumping may occur in the reaction solution, it is preferable to set a flow rate capable of sufficiently removing the water, acetic acid, and the like.

In the reaction solution, in a case where the content of the hydroxyl group included in the solvent which has a hydroxyl group and has 14 to 22 carbon atoms is denoted by A mol, and the content of the carboxylic acid included in the precursor solution and having 6 to 20 carbon atoms is denoted by B mol, A and B preferably satisfy a condition of Expression (I), and more preferably satisfy a condition of Expression (II).

B/(A+B)<0.5 Expression (I)

B/(A+B)<0.46 Expression (II)

By satisfying the condition of Expression (I), the esterification reaction is likely to proceed and the yield of ITO particles is improved.

In a case of the reaction, from the viewpoint that the yield of ITO particles is further improved, it is preferable to satisfy Expression (III).

0.1<B/(A+B)<0.5 Expression (III)

The value of B/(A+B) can be obtained by calculating the number of moles from the amounts of the carboxylic acid and alcohol solvent used in the preparation of the precursor solution in the step (I) and the respective molecular weights.

[Step (III)]

The step (III) is a step of, after the completion of the dropwise addition of the precursor solution, retaining the obtained reaction solution under a temperature condition of 230° C. to 320° C. for 60 minutes to 180 minutes, so-called aging.

After the completion of the dropwise addition of the precursor solution in the step (II), the obtained reaction solution is not immediately cooled, but retained under a temperature condition of 230° C. to 320° C. for 60 minutes to 180 minutes.

The temperature of the reaction solution is not necessarily retained at a constant temperature as long as the temperature is retained in a range of 230° C. to 320° C. within the range of the retention time, and may be initially set to 230° C. and gradually raised, or may be lowered from 320° C. In addition, in a case of using a reaction vessel equipped with a temperature adjusting mechanism, it is sufficient that the temperature of the reaction solution is retained in a range of 230° C. to 320° C. during the retention time even in a case of some temperature fluctuation.

The reaction temperature (temperature of the reaction solution) in the step (II) and the retention temperature in the step (III) may be the same as or different from each other as long as the temperatures are within the respectively defined temperature ranges.

The retention temperature of the reaction solution is in a range of 230° C. to 320° C., preferably 250° C. to 310° C., and more preferably 280° C. to 300° C.

The time for retaining the reaction solution at the above-described temperature is 60 minutes to 180 minutes, preferably 75 minutes to 150 minutes.

By retaining the reaction solution in the above-described temperature range for the above-described time, the defects in the ITO particles, which are a concern in a case of increasing the dropping rate during the reaction, are compensated. That is, by providing the step (III), it is possible to set the plasmon resonance peak of the ITO particles to approximately 1900 nm or less, and absorbing particles of the obtained ITO particles have good absorption in the near infrared region.

Therefore, the ITO particles obtained by the producing method according to the embodiment of the present disclosure can be suitably used for an optical filter in the near infrared region, an optical lens material using wavelength dispersion, and the like.

The content of indium and the content of tin in the obtained ITO particles are measured by inductively coupled plasma (ICP) mass spectrometry.

(Particle Size of ITO Particles)

The number-average particle size of the ITO particles obtained by the producing method according to the embodiment of the present disclosure is preferably 10 nm to 30 nm, more preferably 15 nm to 25 nm, and still more preferably 20 nm to 25 nm.

By setting the number-average particle size within the above-described range, in a case where the ITO particles are blended into a curable composition and the like, scattering in a visible light region is suppressed and an increase in viscosity of the composition is easily suppressed. By suppressing the increase in viscosity of the composition, the particles can be dispersed in a higher concentration, and as a result, curable composition having a lower Abbe number can be obtained.

The number-average particle size can be obtained by observing the particles with a transmission electron microscope (TEM), calculating an equivalent circular size of at least 100 particles, and calculating an arithmetic average value thereof.

In addition, from the viewpoint of controlling the resonance peak sharply, it is desirable that the standard deviation of the number-average particle size is 5 nm or less, and it is more desirable that standard deviation of the number-average particle size is 3 nm or less.

The standard deviation can be obtained by observing the particles with a transmission electron microscope (TEM), calculating an equivalent circular size of at least 100 particles, and calculating a standard deviation thereof.

(Use Aspect of ITO Particles)

The ITO particles obtained by the producing method according to the embodiment of the present disclosure can be used as optical material by being contained in a curable composition.

Examples of the curable composition (hereinafter, sometimes simply referred to as a “composition”) include a composition including the above-described ITO particles obtained by the producing method according to the embodiment of the present disclosure, and a polymerizable compound.

The curable composition is a composition cured by applying energy from the outside, preferably a composition cured by heat or light, and more preferably a composition cured by light.

Hereinafter, a preferred aspect of the curable composition including the ITO particles obtained by the producing method according to the embodiment of the present disclosure will be described together with a producing method thereof.

<Method for Producing Curable Composition>

Examples of the curable composition include a composition including the above-described ITO particles obtained by the producing method according to the embodiment of the present disclosure, and a polymerizable compound.

The method for producing the curable composition including the indium tin oxide particles obtained by the producing method according to the embodiment of the present disclosure is not particularly limited, and a known method for producing a curable composition can be appropriately applied. Among these, it is preferable that the curable composition is produced by the method for producing a curable composition according to the embodiment of the present disclosure described below.

The method for producing a curable composition according to the embodiment of the present disclosure includes a step of obtaining ITO particles by the above-described producing method according to the embodiment of the present disclosure; and a step of obtaining a curable composition having absorption in a near infrared region by mixing the obtained ITO particles and a polymerizable compound.

In a case of using a curable composition as an optical material, it is preferable that the curable composition is a composition having a low refractive index and a low Abbe number.

The Abbe number is a value calculated by Equation 1.

Abbe number ν_{d}=(n_{d}−1)/(n_{f}−n_{c}) Equation 1

In Equation 1, n_{d} represents a refractive index for the D line (wavelength of 587.56 nm), n_{f} represents a refractive index for the F line (wavelength of 486.1 nm), and n_{c} represents a refractive index for the C line (wavelength of 656.3 nm), respectively.

The C line, D line, and F line are the C line, D line, and F line in the Fraunhofer line.

As described above, since the ITO particles obtained by the producing method according to the embodiment of the present disclosure has a peak wavelength of a plasmon resonance absorption in the near infrared region (for example, a wavelength near 1900 nm), a curable composition having a low Abbe number can be realized, which leads to improvement in performance in a case of being used as a diffraction grating lens and improvement in degree of freedom in a case of designing an optical element.

(First Step in Method for Producing Curable Composition)

The method for producing ITO particles, which is a first step in the method for producing a curable composition according to the embodiment of the present disclosure, is the same as the above-described producing method according to the embodiment of the present disclosure, and the preferred aspects are also the same.

In the first step, since the ITO particles obtained in a state of being dispersed in the solvent are in a state of being dispersed in the reaction solution, a step of purifying the ITO particles may be performed by, for example, subjecting the ITO particles dispersed in the reaction solution to centrifugation by adding ethanol so as to precipitate the particles, removing the supernatant, and redispersing the ITO particles in toluene. The step of purifying the ITO particles may be repeated a plurality of times as necessary.

(Second Step in Method for Producing Curable Composition)

The method for producing a curable composition according to the embodiment of the present disclosure has, as a second step, a step of mixing the ITO particles obtained in the above-described first step and a polymerizable compound.

The method of mixing the ITO particles and the polymerizable compound is not particularly limited.

It is preferable that the ITO particles and the polymerizable compound are stirred and mixed until no separation is visually observed and a uniform mixture is obtained.

(Content of ITO Particles)

In the second step, the amount of the ITO particles to be used in a case of mixing the ITO particles and the polymerizable compound is preferably an amount such that the amount of ITO particles in the obtained curable composition with respect to the total solid content of the composition is 18% by mass or more, more preferably an amount such that the amount of ITO particles in the obtained curable composition with respect to the total solid content of the composition is 38% by mass or more, and still more preferably an amount such that the amount of ITO particles in the obtained curable composition with respect to the total solid content of the composition is 43% by mass or more.

In addition, the content with respect to the total solid content of the composition is preferably 80% by mass or less, more preferably 75% by mass or less, and still more preferably 70% by mass or less.

In the present specification, the “total solid content” refers to the total amount of components in the composition, excluding volatile components such as a solvent.

The content of the ITO particles in the curable composition can be calculated, in a case where the composition is subjected to a thermal mass spectrometry and remaining solid components after heating to a temperature (for example, 500° C.) at which liquid components can be completely removed are regarded as ITO particles, as a mass content of the ITO particles with respect to the total solid content of the curable composition to be measured.

(Polymerizable Compound)

A polymerizable compound which can be used in the method for producing a curable composition according to the embodiment of the present disclosure will be described.

By mixing the above-described ITO particles obtained by the producing method according to the embodiment of the present disclosure and the polymerizable compound, a curable composition containing the ITO particles and the polymerizable compound can be obtained.

The polymerizable compound is not particularly limited as long as the polymerizable compound is a compound which can be polymerized and cured. As the polymerizable compound, a radically polymerizable compound is preferable, and an ethylenically unsaturated compound having at least one ethylenically unsaturated group in the molecule is more preferable.

As the ethylenically unsaturated compound, from the viewpoint of easily setting the refractive index of the curable composition after curing to approximately 1.5 to 1.55, which is a suitable value for use, for example, in a diffraction grating lens, a polyfunctional ethylenically unsaturated compound having two or more ethylenically unsaturated groups is preferable, and a polyfunctional (meth)acrylate compound having two or more (meth)acryloxy groups is more preferable.

Examples of the polyfunctional ethylenically unsaturated compound include 1,4-divinylcyclohexane, 1,4-cyclohexanedimethanol divinyl ether, divinylbenzene, 1,6-divinylnaphthalene, ethoxylated bisphenol A divinyl ether, propoxylated bisphenol A di(meth)acrylate; polyethylene glycol di(meth)acrylate, polypropylene glycol di(meth)acrylate, trimethylolethane tri(meth)acrylate, neopentyl glycol di(meth)acrylate, pentaerythritol tri(meth)acrylate, pentaerythritol tetra(meth)acrylate, dipentaerythritol hexa(meth)acrylate, hexanediol di(meth)acrylate, tricyclodecane dimethanol diacrylate, tri(acryloyloroxyethyl) isocyanurate, tris(2-acryloyloxyethyl) isocyanurate, and compounds similar to these compounds.

The curable composition may contain one kind of polymerizable compound or may contain two or more kinds thereof.

The content of the polymerizable compound in the curable composition is preferably 15% by mass to 85% by mass, more preferably 20% by mass to 70% by mass, and still more preferably 30% by mass to 60% by mass with respect to the total solid content of the curable composition.

(Polymerization Initiator)

The curable composition preferably contains a polymerization initiator.

From the viewpoint that the curable composition is an ultraviolet curing-type curable composition, it is preferable to contain a photopolymerization initiator as the polymerization initiator.

The polymerization initiator can be appropriately selected depending on the polymerizable compound contained in the curable composition. For example, in a case where the curable composition includes a radically polymerizable compound as the polymerizable compound, it is preferable that a polymerization initiator which can be included as desired is a radical polymerization initiator.

Hereinafter, a photoradical polymerization initiator which is a preferred aspect as the polymerization initiator will be described.

As the photoradical polymerization initiator, a photoradical polymerization initiator including an acylphosphine oxide structure, an α-hydroxyalkylphenone structure, or an α-aminoalkylphenone structure is preferable.

The photoradical polymerization initiator is not particularly limited in structure, and examples thereof include 2,4,6-trimethylbenzoyldiphenylphosphine oxide, bis(2,4,6-trimethylbenzoyl)phenylphosphine oxide, 2,2-dimethoxy-1,2-diphenylethan-1-one, 1-hydroxycyclohexyl phenylketone, 1-hydroxycyclohexyl phenylketone, 1-[4-(2-hydroxyethoxy)phenyl]-2-hydroxy-2-methyl-1-propan-1-one, 2-hydroxy-1-{4-[4-(2-hydroxy-2-methyl-propionyl)benzyl]phenyl}-2-methyl-propan-1-one, and 2-methyl-1-(4-methylthiophenyl)-2-morpholinopropan-1-one.

A commercially available product may be used as the photoradical polymerization initiator, and specific examples of the commercially available product include IRGACURE (trademark) series manufactured by BASF (for examples, IRGACURE TPO, IRGACURE 819, IRGACURE 651, IRGACURE 184, IRGACURE 1173, IRGACURE 2959, IRGACURE 127, and IRGACURE 907).

In a case where the curable composition includes a polymerization initiator, the polymerization initiator may be included singly or in combination of two or more thereof.

From the viewpoint of wear resistance and high-temperature stretchability of a cured product obtained by using the curable composition, the content of the polymerization initiator in a case where the curable composition includes the polymerization initiator is preferably 0.05% by mass to 10% by mass, more preferably 0.1% by mass to 10% by mass, still more preferably 0.1% by mass to 5% by mass, and particularly preferably 0.5% by mass to 3% by mass with respect to the total mass of the polymerizable compound.

(Dispersant)

The curable composition may contain a dispersant.

By including the dispersant, dispersibility of the ITO particles in the curable composition can be further increased, and as a result, the obtained curable composition easily achieves high visible light transmission characteristics, low Abbe number, and the like.

As the dispersant which can be included in the curable composition, a cationic surfactant, a nonionic surfactant, and an amphoteric surfactant are effective. As a surfactant used as the dispersant, surfactants of polyester, ε-caprolactone, polycarboxylic acid salt, polyphosphoric acid salt, hydrostearic acid salt, amidosulfonic acid salt, polyacrylic acid salt, olefin-maleic acid salt copolymer, acryl-maleic acid salt copolymer, alkylamine acetate, organic phosphoric acids, alkyl fatty acid salt, fatty acid polyethylene glycol ester, silicone, and fluorine can be suitably used, and among these, it is more suitable to use at least one base dispersant selected from the group consisting of ammonia and organic amines.

A commercially available product may be used as the dispersant, and specific examples of the commercially available product include DISPERBYK series (manufactured by BYK Japan KK), Solsperse series (manufactured by Zeneca)/Solsperse series (manufactured by Lubrizol Japan Ltd.), and TAMN series (manufactured by Nikko Chemicals Co., Ltd.). From the viewpoint that dispersibility is easily increased because of adsorbability to the ITO particles and steric hindrance, DISPERBYK-161 (amine type), DISPERBYK-111 (phosphoric acid type), and the like are more preferable.

In a case where the curable composition includes a dispersant, the dispersant may be included singly or in combination of two or more thereof.

The content of the dispersant in a case where the curable composition includes the dispersant is preferably 1% by mass to 30% by mass, more preferably 3% by mass to 20% by mass, and still more preferably 5% by mass to 15% by mass with respect to the total mass of oxide particles in the curable composition.

(Other Components)

The curable composition may contain other components other than the above-described compounds, in addition to the ITO particles, the polymerizable compound, and the polymerization initiator and the dispersant which are preferred optional components described above.

Examples of the other components include a solvent, a polymerization inhibitor, a surfactant other than the above-described dispersant, a plasticizer, and a sensitizer. In the method for producing a curable composition according to the embodiment of the present disclosure, in order to improve curability of the obtained curable composition and suppress the occurrence of non-uniformity inside the film during curing, it is preferable that the curable composition does not contain a solvent.

The curable composition can be produced by stirring and mixing each of these components. The timing of mixing each component is arbitrary, and it is sufficient that each component is appropriately added depending on the physical properties of each component.

(Characteristics of Curable Composition)

Preferred characteristics of the curable composition obtained by the method for producing a curable composition according to the embodiment of the present disclosure will be shown below.

—Abbe Number—

The curable composition including the ITO particles obtained by the producing method according to the embodiment of the present disclosure can achieve a low Abbe number. From such a viewpoint, the Abbe number of the obtained curable composition is preferably 8 to 30, more preferably 10 to 25, and still more preferably 10 to 20.

The Abbe number of the curable composition is measured using a refractometer DR-M2 manufactured by ATAGO CO., LTD.

—Refractive Index—

In the curable composition, the refractive index nD for light having a wavelength of 589 nm is preferably 1.40 to 1.60 and more preferably 1.40 to 1.55.

The refractive index is measured using a refractometer DR-M2 manufactured by ATAGO CO., LTD.

—Visible Light Transmittance—

In the curable composition according to the present disclosure, the visible light transmittance (hereinafter, sometimes simply referred to as “transmittance”) at a wavelength of 405 nm is preferably 85% to 100% and more preferably 90% to 100%.

The visible light transmittance is measured using a spectrophotometer V-670 manufactured by JASCO Corporation, and is a value in a case of being converted into an optical path length of 10 μm.

(Use of Curable Composition)

The curable composition obtained by the method for producing a curable composition according to the embodiment of the present disclosure can be preferably used for producing an optical material having a low Abbe number and low refractive index, and is particularly preferably used for producing a diffraction grating lens. The use of the curable composition is not limited thereto.

### EXAMPLES

Hereinafter, the embodiments of the present disclosure will be more specifically described with reference to Examples. The materials, amounts to be used, proportions, treatment contents, treatment procedures, and the like shown in Examples can be appropriately modified as long as the modifications do not depart from the spirit of the embodiments of the present disclosure. Therefore, the scope of the embodiments of the present disclosure is not limited to the following specific examples.

In the following examples, “parts” and “%” are based on mass unless otherwise specified.

### Example 1

(dropping rate: 1.75 mL/min, retention time: 120 minutes, precursor solution concentration: 0.5 mmol/mL)

First, 75 mL of oleic acid (manufactured by Sigma-Aldrich, Inc., technical grade, 90%), 10.060 g (34.5 mmol) of indium acetate (manufactured by Alfa Aesar, 99.99%), and 1.079 g (3.0 mmol) of tin (IV) acetate (manufactured by Alfa Aesar) were added in a flask, and the mixture was heated at 160° C. for 1 hour under an environment of nitrogen flow to obtain a yellow transparent precursor solution (step (I)). The precursor solution was injected into a syringe under an environment of oxygen concentration of 1 ppm.

90 mL of oleyl alcohol (manufactured by WAKO PURE CHEMICAL CORPORATION, purity: 65% or more) was added in another flask, and heated at 290° in a nitrogen flow. Using a syringe pump, the precursor solution obtained in the step (I) and injected into the syringe was added dropwise to the heated oleyl alcohol at a rate of 1.75 mL/min (step (II)).

After the completion of the dropwise addition of the precursor solution, the temperature of the obtained reaction solution was maintained at 290° C. and retained for 120 minutes (step (III)), and thereafter, the heating was stopped and the reaction solution was cooled to room temperature (25° C.).

After subjecting the obtained reaction solution to centrifugation by adding ethanol so as to precipitate particles, a treatment of removing the supernatant and redispersing the formed ITO particles in toluene was repeated 3 times to obtain a toluene dispersion liquid of ITO particles coordinated with oleic acid.

In a case where the obtained ITO particles were observed with TEM according to the above-described method to measure particle size, the number-average particle size was 21 nm.

### Example 2

(dropping rate: 1.75 mL/min, retention time: 60 minutes)

A toluene dispersion liquid of ITO particles was obtained in the same method as in Example 1, except that, in Example 1, after the completion of the dropwise addition of the precursor solution in the step (II), the time of retaining the temperature of the reaction solution in the step (II) at 290° C. was changed from 120 minutes to 60 minutes.

### Example 3

(dropping rate: 1.75 mL/min, retention time: 180 minutes)

A toluene dispersion liquid of ITO particles was obtained in the same method as in Example 1, except that, in Example 1, after the completion of the dropwise addition of the precursor solution in the step (II), the time of retaining the temperature of the reaction solution in the step (II) at 290° C. was changed from 120 minutes to 180 minutes.

### Example 4

(dropping rate: 1.0 mL/min, retention time: 60 minutes)

A toluene dispersion liquid of ITO particles was obtained in the same method as in Example 1, except that, in Example 1, the dropping rate of the dropwise addition of the precursor solution in the step (I) was changed from 1.75 mL/min to 1.0 mL/min, and after the completion of the dropwise addition of the precursor solution in the step (II), the time of retaining the temperature of the reaction solution in the step (II) at 290° C. was changed from 120 minutes to 60 minutes.

### Example 5

(dropping rate: 1.0 mL/min, retention time: 180 minutes)

A toluene dispersion liquid of ITO particles was obtained in the same method as in Example 1, except that, in Example 1, the dropping rate of the dropwise addition of the precursor solution in the step (I) was changed from 1.75 mL/min to 1.0 mL/min, and after the completion of the dropwise addition of the precursor solution in the step (II), the time of retaining the temperature of the reaction solution in the step (II) at 290° C. was changed from 120 minutes to 180 minutes.

### Comparative Example 1

(dropping rate: 1.75 mL/min, retention time: 30 minutes)

A toluene dispersion liquid of ITO particles was obtained in the same method as in Example 1, except that, in Example 1, after the completion of the dropwise addition of the precursor solution in the step (II), the time of retaining the temperature of the reaction solution in the step (II) at 290° C. was changed from 120 minutes to 30 minutes.

### Comparative Example 2

(dropping rate: 1.75 mL/min, retention time: 240 minutes)

A toluene dispersion liquid of ITO particles was obtained in the same method as in Example 1, except that, in Example 1, after the completion of the dropwise addition of the precursor solution in the step (II), the time of retaining the temperature of the reaction solution in the step (II) at 290° C. was changed from 120 minutes to 240 minutes.

### Example 6

(dropping rate: 3.5 mL/min, retention time: 180 minutes)

A toluene dispersion liquid of ITO particles was obtained in the same method as in Example 3, except that, in Example 3, the dropping rate of the dropwise addition of the precursor solution in the step (I) was changed from 1.75 mL/min to 3.5 mL/min.

### Example 7

(dropping rate: 3.5 mL/min, retention time: 60 minutes)

A toluene dispersion liquid of ITO particles was obtained in the same method as in Example 4, except that, in Example 4, the dropping rate of the dropwise addition of the precursor solution in the step (I) was changed from 1.75 mL/min to 3.5 mL/min.

### Comparative Example 3

(dropping rate: 1.0 mL/min, retention time: 30 minutes)

A toluene dispersion liquid of ITO particles was obtained in the same method as in Comparative Example 1, except that, in Comparative Example 1, the dropping rate of the dropwise addition of the precursor solution in the step (I) was changed from 1.75 mL/min to 1.0 mL/min.

### Comparative Example 4

(dropping rate: 1.0 mL/min, retention time: 240 minutes)

A toluene dispersion liquid of ITO particles was obtained in the same method as in Comparative Example 2, except that, in Comparative Example 2, the dropping rate of the dropwise addition of the precursor solution in the step (I) was changed from 1.75 mL/min to 1.0 mL/min.

### Example 8

(dropping rate: 1.75 mL/min, retention time: 120 minutes, precursor solution concentration: 0.2 mmol/mL)

A toluene dispersion liquid of ITO particles was obtained in the same method as in Example 1, except that 75 mL of oleic acid, 4.024 g (13.8 mmol) of indium acetate, and 0.432 g (1.2 mmol) of tin (IV) acetate were added in a flask, and the mixture was heated at 160° C. for 1 hour under an environment of nitrogen flow to obtain a yellow transparent precursor solution.

### Example 9

(dropping rate: 1.75 mL/min, retention time: 120 minutes, precursor solution concentration: 0.6 mmol/mL)

A toluene dispersion liquid of ITO particles was obtained in the same method as in Example 1, except that 75 mL of oleic acid, 12.072 g (41.4 mmol) of indium acetate, and 1.295 g (3.6 mmol) of tin (IV) acetate were added in a flask, and the mixture was heated at 160° C. for 1 hour under an environment of nitrogen flow to obtain a yellow transparent precursor solution.

### Example 10

(dropping rate: 1.75 mL/min, retention time: 120 minutes, precursor solution amount: 50 mL) 50 mL of oleic acid, 6.707 g (23.0 mmol) of indium acetate, and 0.719 g (2 mmol) of tin (IV) acetate were added in a flask, and the mixture was heated at 160° C. for 1 hour under an environment of nitrogen flow to obtain a yellow transparent precursor solution.

A toluene dispersion liquid of ITO particles was obtained in the same method as in Example 1, except that the amount of oleyl alcohol added in another flask was changed from 90 mL to 60 mL.

### Example 11

(dropping rate: 1.75 mL/min, retention time: 120 minutes, precursor solution amount: 100 mL)

100 mL of oleic acid, 13.414 g (46.0 mmol) of indium acetate, and 1.438 g (4 mmol) of tin (IV) acetate were added in a flask, and the mixture was heated at 160° C. for 1 hour under an environment of nitrogen flow to obtain a yellow transparent precursor solution.

A toluene dispersion liquid of ITO particles was obtained in the same method as in Example 1, except that the amount of oleyl alcohol added in another flask was changed from 90 mL to 120 mL.

### Comparative Example 5

(dropping rate: 1.75 mL/min, retention time: 30 minutes, precursor solution amount: 100 mL)

A toluene dispersion liquid of ITO particles was obtained in the same method as in Example 11, except that, after the completion of the dropwise addition of the precursor solution in the step (I), the retention time of the temperature of the reaction solution in the step (II) was changed from 120 minutes to 30 minutes.

### Example 12

(Synthesis temperature: 270° C.)

A toluene dispersion liquid of ITO particles was obtained in the same method as in Example 1, except that, in the step (II), the temperature of the oleyl alcohol was changed from 290° C. to 270° C., and in the step (III), the temperature of the reaction solution after the completion of the dropwise addition of the precursor solution was retained at 270° C. for 120 minutes.

### Example 13

(Synthesis temperature: 310° C.) A toluene dispersion liquid of ITO particles was obtained in the same method as in Example 1, except that, in the step (II), the temperature of the oleyl alcohol was changed from 290° C. to 310° C., and in the step (III), the temperature of the reaction solution after the completion of the dropwise addition of the precursor solution was retained at 310° C. for 120 minutes.

### Example 14

(Synthesis temperature: 290° C., retention temperature: 270° C.)

75 mL of oleic acid (manufactured by Sigma-Aldrich, Inc., technical grade, 90%), 10.060 g (34.5 mmol) of indium acetate (manufactured by Alfa Aesar, 99.99%), and 1.079 g (3.0 mmol) of tin (IV) acetate (manufactured by Alfa Aesar) were added in a flask, and the mixture was heated at 160° C. for 1 hour under an environment of nitrogen flow to obtain a yellow transparent precursor solution (step (I)). The precursor solution was injected into a syringe under an environment of oxygen concentration of 1 ppm.

90 mL of oleyl alcohol (manufactured by WAKO PURE CHEMICAL CORPORATION, 65% or more) was added in another flask, and heated at 290° in a nitrogen flow. Using a syringe pump, the precursor solution injected into the syringe was added dropwise to the heated oleyl alcohol at a rate of 1.75 mL/min (step (II)).

After the completion of the dropwise addition of the precursor solution, the temperature of the obtained reaction solution was set to 270° C. and the obtained reaction solution was retained at 270° C. for 120 minutes (step (III)), and thereafter, the heating was stopped and the reaction solution was cooled to room temperature (25° C.).

After subjecting the obtained reaction solution to centrifugation by adding ethanol so as to precipitate particles, a treatment of removing the supernatant and redispersing the particles in toluene was repeated 3 times to obtain a toluene dispersion liquid of ITO particles coordinated with oleic acid.

<Evaluation of Absorption Characteristics of ITO Particles>

The toluene dispersion liquids of ITO particles obtained by the producing method of Examples 1 to 3 and Comparative Examples 1 and 2 were diluted with toluene to a concentration of solid contents of approximately 0.0025%, and absorption characteristics were measured using an optical cell having an optical path length of 1 cm.

The measurement was carried out using an UV-VIS-NIR spectrophotometer V-670 manufactured by JASCO Corporation.

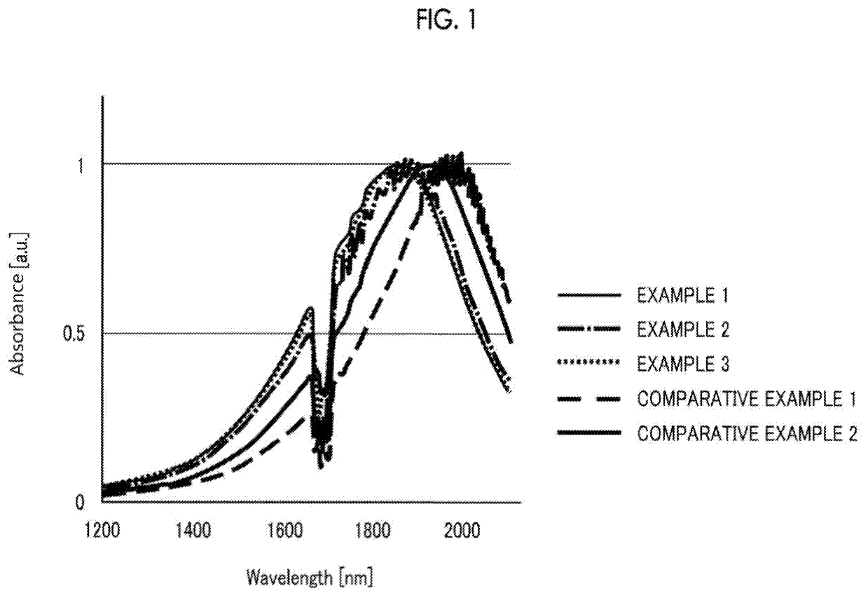

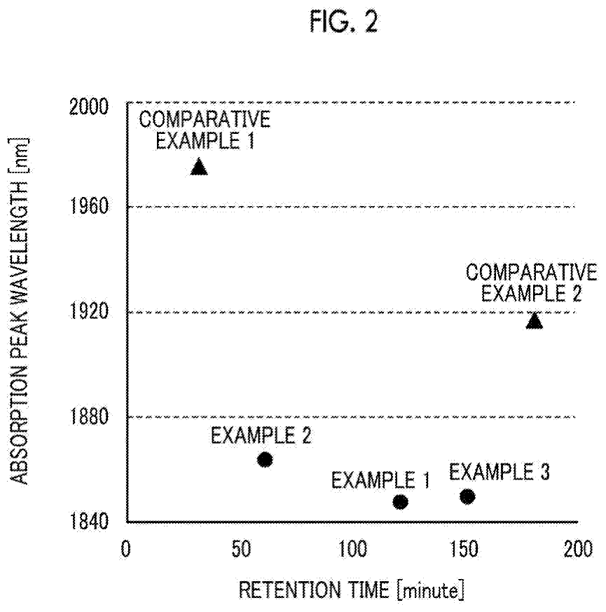

The results are shown in FIG. 1. In addition, FIG. 2 shows a draw plotting peak wavelength of plasmon absorption in respective ITO particles.

It is understood that, in a case where the retention time changes from 30 minutes to 60 minutes, the plasmon absorption wavelength shifts to the short wavelength side, in a case where the retention time is set to in a range of 60 minutes to 180 minutes, the plasmon absorption wavelength hardly shifts, and in a case where the retention time is set to 240 minutes, the plasmon absorption wavelength shifts to the long wavelength side again.

<Production and Evaluation of Curable Composition>

36 μL (microliter) of DISPERBYK-106 manufactured by BYK Japan KK was added, as a dispersant, to the toluene dispersion liquid (ITO particles content: 420 mg) of ITO particles obtained by the producing method of Examples and Comparative Examples, and 533 μL of 1,6-hexanediol diacrylate was further added thereto as a polymerizable compound, and the mixture was stirred and mixed with a hot stirrer at 40° C. for 1 hour (second step in the method for producing a curable composition).

The toluene solvent was removed from the obtained mixed solution using an evaporator to obtain a curable composition containing ITO particles dispersed in the acrylate as a polymerizable compound. The obtained curable composition containing ITO particles was evaluated using a refractometer DR-M2 manufactured by ATAGO CO., LTD.

That is, using the toluene dispersion liquid of ITO particles in Examples and Comparative Examples, the curable composition including ITO particles was prepared according to the above-described method, and the refractive index and Abbe number of the curable composition were evaluated.

In a case of a specimen having a strong plasmon resonance in the near infrared region, a sample in which the curable composition was diluted to approximately 0.01% by mass was prepared, and the absorption characteristics were measured.

The Abbe number is an index indicating the wavelength dispersion of the refractive index in the visible light region.

The Abbe number (ν_{d}) is a value calculated by Equation 1.

Abbe number ν_{d}=(n_{d}−1)/(n_{f}−n_{c}) Equation 1

In Equation 1, n_{d} represents a refractive index for the D line (wavelength of 587.56 nm), n_{f} represents a refractive index for the F line (wavelength of 486.1 nm), and n_{c} represents a refractive index for the C line (wavelength of 656.3 nm), respectively.

The C line, D line, and F line are the C line, D line, and F line in the Fraunhofer line. The evaluation results are shown in Table 1.

TABLE 1

| | Absorption peak | | |
|---|---|---|---|
| | center wavelength | n_{d} | |
| | [nm] | (λ = 589 nm) | ν_{d} |
| Example 1 | 1848 | 1.494 | 17.3 |
| Example 2 | 1863 | 1.4946 | 17.9 |
| Example 3 | 1850 | 1.4948 | 18.0 |
| Example 4 | 1802 | 1.4949 | 16.6 |
| Example 5 | 1794 | 1.4943 | 16.6 |
| Comparative Example 1 | 1975 | 1.4951 | 22.1 |
| Comparative Example 2 | 1916 | 1.4962 | 20.5 |
| Example 6 | 1835 | 1.494 | 17.7 |
| Example 7 | 1852 | 1.4942 | 17.8 |
| Comparative Example 3 | 1923 | 1.4961 | 21.6 |
| Comparative Example 4 | 1905 | 1.4959 | 20.3 |
| Example 8 | 1790 | 1.4941 | 17.0 |
| Example 9 | 1836 | 1.495 | 17.8 |
| Example 10 | 1793 | 1.4931 | 16.9 |
| Comparative Example 5 | 1966 | 1.4958 | 22.9 |
| Example 11 | 1791 | 1.4935 | 16.9 |
| Example 12 | 1833 | 1.4943 | 17.6 |
| Example 13 | 1762 | 1.4942 | 16.0 |
| Example 14 | 1850 | 1.4943 | 17.5 |

From the results shown in Table 1, it is understood that the curable composition including the ITO particles obtained by the producing method of Examples has a low Abbe number (ν_{d}) of 19 or less and a large wavelength dispersion.

Since the curable composition has a low Abbe number, it can be expected that a cured product of the curable composition also has a low Abbe number.

Therefore, in a case where the obtained curable composition is used as a diffraction grating, the height of the diffraction grating can be lowered, and it is possible to significantly reduce the occurrence of flare. Therefore, the ITO particles and curable composition obtained by the producing method according to the embodiment of the present disclosure can be suitably used for various uses such as an optical material.

The disclosure of JP2018-042005 filed on Mar. 8, 2018 is incorporated in the present disclosure by reference.

All documents, patent applications, and technical standards described in the present disclosure are incorporated herein by reference to the same extent as in a case of being specifically and individually noted that individual documents, patent applications, and technical standards are incorporated by reference.

What is claimed is:

1. A method for producing indium tin oxide particles, the method comprising:
a step of obtaining a precursor solution including indium and tin by heating an indium carboxylate having 1 to 3 carbon atoms and a tin carboxylate having 1 to 3 carbon atoms in a solvent including a carboxylic acid having 6 to 20 carbon atoms;
a step of obtaining a reaction solution including indium tin oxide particles by adding dropwise, at a dropping rate of 1.0 mL/min or more, the obtained precursor solution to a solvent which has a hydroxyl group, has 14 to 22 carbon atoms, and has a temperature of 230° C. to 320° C.; and
a step of, after a completion of the dropwise addition of the precursor solution, retaining the obtained reaction solution under a temperature condition of 230° C. to 320° C. for 60 minutes to 180 minutes.

2. The method for producing indium tin oxide particles according to claim 1,
wherein, in the step of obtaining a precursor solution including indium and tin, an amount of the indium carboxylate having 1 to 3 carbon atoms and the tin carboxylate having 1 to 3 carbon atoms is used such that an amount of tin with respect to a total amount of indium and tin is 0.05 to 0.15 in a molar ratio.

3. The method for producing indium tin oxide particles according to claim 1,
wherein a total molar concentration of metals included in the precursor solution is 0.1 mmol/mL or more.

4. The method for producing indium tin oxide particles according to claim 1,
wherein, in a case where a content of the hydroxyl group included in the solvent which has a hydroxyl group and has 14 to 22 carbon atoms is denoted by A mol, and a content of the carboxylic acid included in the precursor solution and having 6 to 20 carbon atoms is denoted by B mol, A and B satisfy a condition of Expression (I).
B/(A+B)<0.5 Expression (I)

5. The method for producing indium tin oxide particles according to claim 1,
wherein the carboxylic acid having 6 to 20 carbon atoms includes oleic acid.

6. The method for producing indium tin oxide particles according to claim 1,
wherein the indium carboxylate having 1 to 3 carbon atoms includes indium acetate, and
the tin carboxylate having 1 to 3 carbon atoms includes tin acetate.

7. The method for producing indium tin oxide particles according to claim 1,
wherein the solvent which has a hydroxyl group and has 14 to 22 carbon atoms includes oleyl alcohol.

8. A method for producing a curable composition, the method comprising:
a step of obtaining indium tin oxide particles by the method for producing indium tin oxide particles according to claim 1; and
a step of obtaining a curable composition having absorption in a near infrared region by mixing the obtained indium tin oxide particles and a polymerizable compound.
